(19) United States
(12) Patent Application Publication
(10) Pub. No.: US 2026/0316072 A1
(43) Pub. Date: Oct. 15, 2026

(54) MICROFLUIDIC FLOW VELOCITY PRECISE-CONTROL DEVICE USING SYNCHRONOUSLY OPERATING DUAL VALVES AND MICROFLUIDIC FLOW VELOCITY PRECISE-CONTROL METHOD USING SAME

(71) Applicant: Korea Research Institute of Standards and Science, Daejeon (KR)

(72) Inventors: Sang-Ryoul Park, Daejeon (KR); Inchul Yang, Daejeon (KR); Hee-Bong Yoo, Daejeon (KR)

(21) Appl. No.: 19/120,058

(22) PCT Filed: Oct. 11, 2023
(86) PCT No.: PCT/KR2023/015589

§ 371 Date: Apr. 10, 2025

(30) Foreign Application Priority Data
Oct. 11, 2022 (KR) 10-2022-0129739

(51) Int. Cl. B01L 3/00

(52) U.S. Cl. CPC B01L 3/502715; B01L 2400/06; B01L 2400/082

(57) ABSTRACT

The present invention relates to a microfluidic flow velocity precise-control device using synchronously operating dual valves and a microfluidic flow velocity precise-control method using same, wherein the microfluidic flow velocity precise-control device using synchronously operating dual valves and the microfluidic flow velocity precise-control method using same are configured to perform synchronized operations in order to precisely control the flow velocity of a microfluid. Therefore, the present disclosure can precisely control the flow velocity of a microfluid.

### TECHNICAL FIELD

The present disclosure relates to a microfluidic flow velocity precise-control device using synchronously operating dual valves and a microfluidic flow velocity precise-control method using the same, and more particularly, to a microfluidic flow velocity precise-control device using synchronously operating dual valves to synchronously operate the flow velocity of a microfluid and a microfluidic flow velocity precise-control method using the same.

### BACKGROUND ART

Microfluidic devices are used in various fields such as biochemical analysis and biosample analysis for disease diagnosis. The microfluidic devices include micro-devices such as capillary flow paths, microfluidic chips, and lab-on-a-chips, and are equipped with microfluidic channels and microstructures.

Various types of microfluidic devices described above may be used to analyze specific components in chemical samples or biochemical samples, and may be used for tissue cell culture and drug testing using the same in microchambers. In addition, two or more sample solutions can be mixed in the microfluidic device to conduct chemical reactions, and can also be used for manufacturing functional materials. In this way, the microfluidic devices can be applied to various fields, and are being utilized for various purposes in various fields.

The amount of sample solution injected into the microfluidic channel of the microfluidic device is very small, so it is important to control the movement of a trace of sample solution to be injected into the microfluidic channel.

However, the amount of sample solution injected into the microfluidic channel of the microfluidic device is very small, so it is important to control the movement of the trace of sample solution to be injected into the microfluidic channel. However, there are realistically difficult problems as follows. In the case of a fluid flowing through a pipe with a large diameter, the transport of the fluid is easily controlled by applying pressure or vacuum. However, in the case of the fluid in the microfluidic channel, a frictional force acting on a wall of a fluidic channel acts relatively very large, and when a large pressure or vacuum is applied to overcome the frictional force, the flow velocity becomes very fast, making it difficult to transport a very small amount of fluid.

Conventionally. Korean Patent No. 10-2341588 (Dec. 16, 2021) discloses a microfluidic control device and a microfluidic control method using the same in which a fluid bridge is formed between a first flat plate and a second flat plate, and then a fluid is sucked through a flow channel to reduce a contact angle of a contact portion of a fluid existing on each of the first plate and the second plate, thereby separating the fluid bridge and precisely controlling the amount of fluid.

However, the conventional microfluidic control device had a problem in that it is difficult to precisely control the desired amount of fluid.

### DISCLOSURE

### Technical Problem

An object of the present disclosure provides a microfluidic flow velocity precise-control device using synchronously operating dual valves that can be synchronized to precisely control the flow velocity of a microfluid, and a microfluidic flow velocity precise-control method using the same.

### Technical Solution

In one general aspect, a microfluidic control device 1000 using synchronously operating dual valves includes: a microfluidic channel 100 in a form of a capillary; a pressure transfer flow path 200 that is connected to one side of the microfluidic channel 100; a first synchronization unit that is connected to one side of the pressure transfer flow path 200; a second synchronization unit that is connected to the other side of the pressure transfer flow path 200; and a synchronization valve controller 6W) that is connected in series with a first control unit and a second control unit.

In another general aspect, a microfluidic control method using dual valves includes: a first synchronization step (S100) of controlling a first synchronization valve 310, which is connected to one side of a pressure transfer flow path 200 connected to one side of a microfluidic channel 100, by a synchronization valve controller 600 connected to a first conductor 610; and a second synchronization step (S200) of controlling a second synchronization valve 320, which is connected to the other side of the pressure transfer flow path 200 connected to one side of the microfluidic channel 100, by a synchronization valve controller 600 connected to a second conductor 620.

### Advantageous Effects

Therefore, a microfluidic flow velocity precise-control device using synchronously operating dual valves of the present disclosure can perform synchronous operation in which a first synchronization valve and a second synchronization valve operate with a fixed time difference δt, so a microfluidic flow in the microfluidic channel can be precisely controlled.

In addition, the microfluidic flow velocity precise-control device using synchronously operating dual valves of the present disclosure can arbitrarily adjust the strength and action time of effective vacuum transmitted to a microfluidic channel connected to a pressure transfer flow path, so the microfluidic flow in the microfluidic channel can be precisely controlled and various flow velocities of the microfluid can be obtained.

### BRIEF DESCRIPTION OF THE DRAWINGS

FIG. 1 is a schematic diagram of a microfluidic control device using synchronously operating dual valves of the present disclosure.

FIG. 2 is a step diagram of a microfluidic control method using synchronously operating dual valves of the present disclosure.

FIG. 3 is a schematic diagram according to Example 1 of a microfluidic control device using synchronously operating dual valves of the present disclosure.

FIG. 4 is a schematic diagram according to Example 2 of a microfluidic control device using synchronously operating dual valves of the present disclosure.

FIG. 5 is a graph of synchronization operation according to a time difference between a first synchronization valve and a second synchronization valve according to Examples 1 and 2 of the microfluidic control device using synchronously operating dual valves of the present disclosure.

FIG. 6 is an experimental result of operating the microfluidic control device using synchronously operating dual valves of the present disclosure.

FIG. 7 is an actual photograph of the microfluidic control device using synchronously operating dual valves of the present disclosure.

### BEST MODE

A microfluidic control device 1000 using synchronously operating dual valves according to the present disclosure includes: a microfluidic channel 100 in a form of a capillary; a pressure transfer flow path 200 that is connected to one side of the microfluidic channel 100; a first synchronization unit that is connected to one side of the pressure transfer flow path 200; a second synchronization unit that is connected to the other side of the pressure transfer flow path 200; and a synchronization valve controller 600 that is connected in series with a first control unit and a second control unit.

In addition, the first control unit may include a first synchronization valve 310 connected to one side of the pressure transfer flow path 200, a first pressure source 510 connected to the first synchronization valve 310 through a first pipe to apply pressure, and a synchronization valve controller 600 connected to the first synchronization valve 310 through a first conductor 610 to control an applied time.

In addition, the second control unit may include a second synchronization valve 320 connected to one side of the pressure transfer flow path 200, a second pressure source 520 connected to the second synchronization valve 320 through a second pipe 420 to apply pressure, and a synchronization valve controller 600 connected to the second synchronization valve 320 through a second conductor 620 to control an applied time.

In addition, the synchronization valve controller may operate the first synchronization valve 310 and the second synchronization valve 320 at preset time intervals.

In addition, the synchronization valve controller may operate the first synchronization valve 310 and the second synchronization valve 320 at a fixed time difference δt in a range of 0 to ±100 ms.

In addition, the microfluidic channel 100 may include a fluid in a range of 0.1 to 500 μL.

In addition, the first synchronization valve 310 may apply negative or positive pressure to the pressure transfer flow path 200 by the operation of the first pressure source 510.

In addition, the second synchronization valve 320 may control the pressure applied to the pressure transfer flow path 200 by the operation of the second pressure source 520.

Next, a microfluidic control method using dual valves according to the present disclosure includes: a first synchronization step (S100) of controlling a first synchronization valve 310, which is connected to one side of a pressure transfer flow path 200 connected to one side of a microfluidic channel 100, by a synchronization valve controller 600 connected to a first conductor 610; and a second synchronization step (S200) of controlling a second synchronization valve 320, which is connected to the other side of the pressure transfer flow path 200 connected to one side of the microfluidic channel 100, by a synchronization valve controller 600 connected to a second conductor 620.

In addition, the first synchronization step (S100) may include a first pressure application step (S110) of applying pressure to the first synchronization valve 310 by a first pressure source 510 connected to the first synchronization valve 310 through a first pipe, and after the first pressure application step (S110), a first control step (S120) of controlling a time applied to the first synchronization valve 310 by the synchronization valve controller 600 connected to the first synchronization valve 310 through the first conductor 610.

In addition, the second synchronization step (S200) may include a second pressure application step (S210) of applying pressure to the second synchronization valve 320 by the second pressure source 520 connected to the second synchronization valve 320 through a second pipe 420, and after the second pressure application step (S210), a second control step (S220) of controlling a time applied to the second synchronization valve 320 by the synchronization valve controller 600 connected to the second synchronization valve 320 through a second conductor 620.

In addition, in the first synchronization step (S100) and the second synchronization step (S200), the first synchronization valve 310 and the second synchronization valve 320 may operate with a fixed time difference δt by the synchronization valve controller 600.

In addition, in the first synchronization step (S100) and the second synchronization step (S200), the first synchronization valve 310 and the second synchronization valve 320 may operate with the fixed time difference δt in the range of 0 to ±100 ms by the synchronization valve controller 600.

### MODE FOR INVENTION

Microfluid in a microfluidic device has a problem in that it is difficult to control a flow velocity by applying a positive pressure or a negative pressure (vacuum) due to the frictional force between a duct wall and a fluid, which has a relatively large influence. In particular, when a sufficiently large pressure or vacuum is applied to overcome the frictional force, the flow velocity becomes very fast, making it impossible to precisely control the flow velocity at a low speed for handling trace samples. This phenomenon may slow down the development of biochemical microanalysis technology that handles trace samples and reagents. Therefore, the present disclosure controls a synchronization valve to be synchronized by a synchronization valve controller for microfluid control to precisely control the flow of a microfluid in a microfluidic channel, thereby solving the above problems.

Hereinafter, the present disclosure will be described in more detail below through specific examples or Examples including the attached drawings. However, the following specific examples or Examples are only one reference example for describing the present disclosure in detail, and the present disclosure is not limited thereto and may be implemented in various forms.

In addition, unless otherwise defined, all technical and scientific terms have the same meaning as commonly understood by one of ordinary skill in the art to which this invention pertains. The terms as used for description herein are used only for the purpose of effectively describing specific Examples and are not intended to limit the invention.

Also, the singular forms used in the specification and appended claims are intended to include the plural forms as well, unless the context specifically dictates otherwise.

In addition, unless explicitly described to the contrary, “including” any component will be understood to imply the inclusion of other components rather than the exclusion of other components.

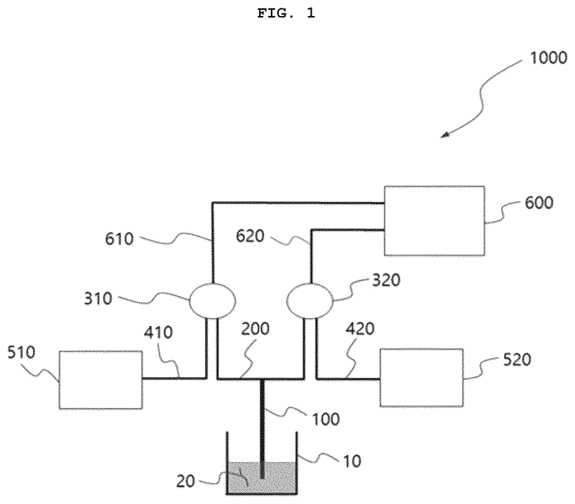

FIG. 1 is a schematic diagram illustrating a microfluidic control device using synchronously operating dual valves. Referring to FIG. 1, a microfluidic control device 1000 using synchronously operating dual valves of the present disclosure includes a microfluidic channel 100 in the form of a capillary, a pressure transfer flow path 200 connected to one side of the microfluidic channel 100, a first control unit connected to one side of the pressure transfer flow path 200 and a second control unit connected to the other side of the pressure transfer flow path 200, and a synchronous valve controller 600 connected in series with the first control unit and the second control unit.

Here, since the microfluidic control device 1000 using synchronously operating dual valves may be used to precisely control the flow of a microfluid in the microfluidic channel 100, one side of the microfluidic channel 100 may be connected to the pressure transfer flow path 200, and the other side may be immersed in the sample solution 10 in the sample solution 10 tank. Therefore, by using the microfluidic channel 100, the sample solution 10 may be precisely sucked or discharged in a very small amount by the operation of the microfluidic control device 1000 using the synchronously operating dual valves. Here, a diameter of the microfluidic channel may be provided as 0.01 to 1 mm. When the diameter of the microfluidic channel is smaller than 0.01 mm, the applied pressure should be increased, but when the pressure increases, precise control of the microfluid becomes impossible. In addition, when the diameter of the microfluidic channel is larger than 1 mm, the flow velocity of the microfluid may become faster than the applied pressure, making it difficult to control the flow velocity of the microfluid. Therefore, in the present disclosure, the diameter range of the microfluidic channel is designed to be 0.01 to 1 mm to smoothly control the flow velocity of the microfluid.

In addition, the first control unit may include a first synchronization valve 310 connected to one side of the pressure transfer flow path 200 to control the flow of fluid, a first pressure source 510 connected to the first synchronization valve 310 through a first pipe to apply pressure, and a synchronization valve controller 600 connected to the first synchronization valve 310 through a first conductor 610 to control the applied pressure.

In addition, herein, the second control unit may include a second synchronization valve 320 connected to other side of the pressure transfer flow path 200 to control the flow of fluid, a second pressure source 520 connected to the second synchronization valve 320 through a second pipe 420 to apply pressure, and a synchronization valve controller 600 connected to the second synchronization valve 320 through a second conductor 620 to control the applied pressure.

The synchronization valve controller may control the operation of the first synchronization valve 310 and the second synchronization valve 320. Here, the first pressure source 510 and the second pressure source 520 may have different pressure intensities. The first pressure source 510 and the second pressure source may be connected to the first synchronization valve 310 and the second synchronization valve 320 through the first pipe and the second pipe 420, and the pressure may be applied by the first pressure source 510 and the second pressure source 520. In addition, the first synchronization valve 310 and the second synchronization valve 320 may operate with a fixed time difference δt by the control of the synchronization valve controller. Therefore, the effective pressure intensity applied within the pressure transfer flow path 200 is precisely controlled, so the flow of a small amount of fluid included in the microfluidic channel 100 may be precisely controlled. Here, the microfluidic channel 100 may include a fluid in a range of 0.1 to 500 μL. More specifically, the first pressure source 510 and the second pressure source 520 have a mutual pressure difference by the synchronous valve controller, and may add the positive pressure or the negative pressure to the pressure transfer flow path 200 to adjust the suction force in the microfluidic channel 100 connected to the pressure transfer flow path 200, thereby controlling the flow rate of the microfluid.

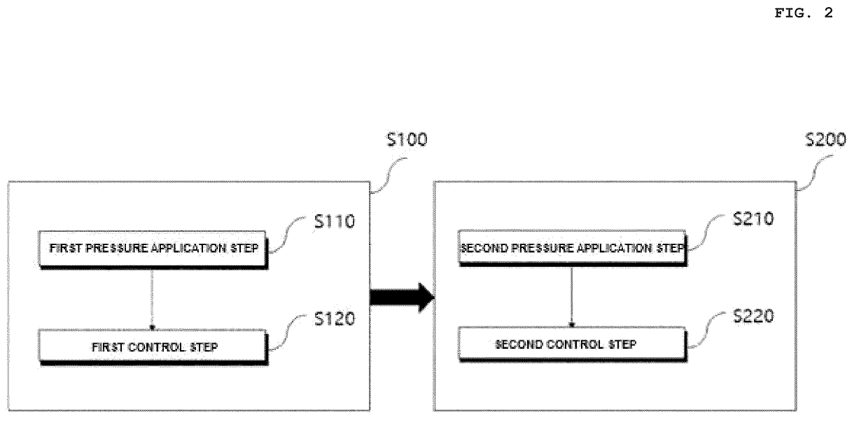

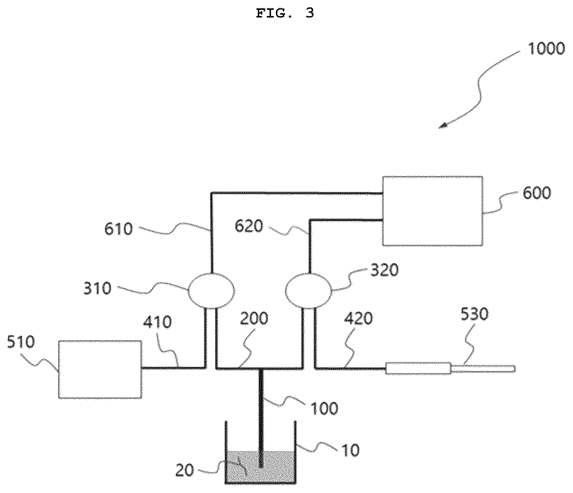

FIG. 2 illustrates a step diagram of a microfluidic flow velocity precise-control method using synchronously operating dual valves of the present disclosure Next, a microfluidic flow velocity precise-control method (S1000) using synchronously operating dual valves of FIG. 3 according to the present disclosure includes: a first synchronization step (S100) of controlling a first synchronization valve 310, which is connected to one side of the pressure transfer flow path 200 connected to one side of the microfluidic channel 100, by the synchronization valve controller 600 connected to a first conductor 610; and a second synchronization step (S200) of controlling a second synchronization valve 320, which is connected to the other side of the pressure transfer flow path 200 connected to one side of the microfluidic channel 100, by the synchronization valve controller 600 connected to a second conductor 620.

Here, the first synchronization step (S100) may further include a first pressure application step (S110) of applying pressure to the first synchronization valve 310 by a first pressure source 510 connected to the first synchronization valve 310 through a first pipe, and after the first pressure application step (S10), a first control step (S120) of controlling a time applied to the first synchronization valve 310 by the synchronization valve controller 600 connected to the first synchronization valve 310 through the first conductor 610.

In addition, here, the second synchronization step (S200) may further include a second pressure application step (S210) of applying pressure to the second synchronization valve 320 by the second pressure source 520 connected to the second synchronization valve 320 through a second pipe 420, and after the second pressure application step (S210), a second control step (S220) of controlling a time applied to the second synchronization valve 320 by the synchronization valve controller 600 connected to the second synchronization valve 320 through a second conductor 620.

Next, the microfluidic flow velocity precise-control method using the synchronously operating dual valves according to the present disclosure is described as follows. In the first synchronization step (S100), the pressure may be applied to the first synchronization valve 310 by the first pressure source 510, and the time for which the pressure applied by the first pressure source 510 is applied may be controlled by the synchronization valve controller 600. In addition, in the second synchronization step (S200), the pressure may be applied to the second synchronization valve 310 by the second pressure source 520, and the time for which the pressure applied by the second pressure source 520 is applied may be controlled by the synchronization valve controller.

Therefore, the first synchronization valve 310 and the second synchronization valve 320 may operate with a fixed time difference δt by the synchronization valve controller 600, and more specifically, the first synchronization valve 310 and the second synchronization valve 320 may operate with a fixed time difference δt in the range of 0 to ±100 ms by the synchronization valve controller 600, so a vacuum level is adjusted with a minute difference. As a result, the microfluid flow in the microfluidic channel 100 may be precisely controlled and various flow velocities of the microfluid may be obtained.

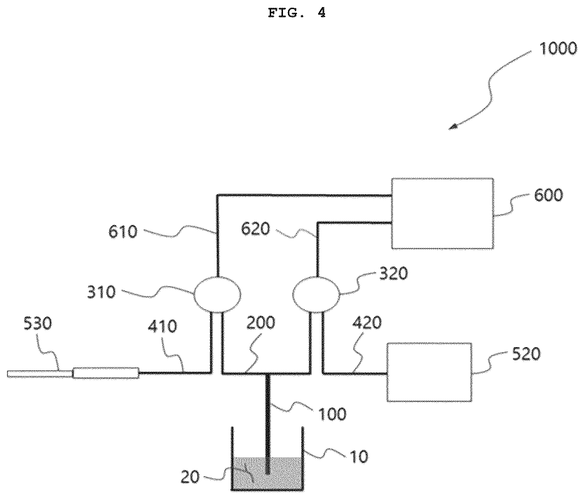

FIG. 3 is a schematic diagram illustrating Example 1 of the microfluidic control device using synchronously operating dual valves according to the present disclosure, and FIG. 4 is a schematic diagram illustrating Example 2 of the microfluidic control device using synchronously operating dual valves according to the present disclosure.

Referring to FIGS. 3 and 4 described above, Examples 1 and 2 for the microfluidic flow velocity precise-control method using the microfluidic flow velocity precise-control device using synchronously operating dual valves will be described in detail.

As the first pressure source 510, a NF30-KFDC diaphragm pressure/vacuum pump from KNF Co., was used, and in the Example of the present disclosure, a self-manufactured plastic buffer container with a capacity of 100 mL connected to the first pressure source 510 was used. The vacuum level of the second pressure source 520 (pressure/vacuum pump) was maintained at −55 to −65 kPa. In this case, the vacuum level was measured using a pressure/vacuum sensor, MPX5100DP from NXP Semiconductor Co.

The first synchronization valve 310 and the second synchronization valve 320 used UMB1-T1 solenoid valves from CKD Co., respectively. The pressure transfer flow path used a T-shaped connection so that it may be connected to the first synchronization valve and the second synchronization valve 320.

Here, as illustrated in FIG. 3, as in Example 1, one side of the first synchronization valve 310 was connected to the first pressure source 510, and the other side was connected to the pressure transfer flow path 200. In addition, one side of the second synchronization valve 320 was connected to the pressure transfer flow path 200, and the other side was connected using a silicone tube with an outer diameter of 3 mm and an inner diameter of 1.0 mm and a transparent FEP tube with an outer diameter of 1.6 mm and an inner diameter of 0.5 mm to form an atmospheric pressure inlet pipe 530.

In addition, as illustrated in FIG. 4, in Example 2, one side of the first synchronization valve 310 was connected to the pressure transfer flow path 200, and the other side was connected to the pressure transfer flow path 200. In addition, one side of the second synchronization valve 320 was connected to the second pressure source 520, and the other side was connected using the silicone tube with an outer diameter of 3 mm and an inner diameter of 1.0 mm and the transparent FEP tube with an outer diameter of 1.6 mm and an inner diameter of 0.5 mm to form the atmospheric pressure inlet pipe 530.

In addition, as the microfluidic channel 100, PEEK tubing with an inner diameter of 0.175 mm, an outer diameter of 1.6 mm, and a length of 60 mm was used.

In addition, a synchronization valve controller 600 was used to operate the first synchronization valve 310 and the second synchronization valve 320 with a fixed time difference δt, and in order to operate the synchronization valve controller 600 with a fixed time difference, the synchronization valve controller 600 was programmed using Arduino to control the operation of the first synchronization valve 310 and the second synchronization valve 320 and acquire signals. In this process, the first synchronization valve 310 and the second synchronization valve 320 were configured to be synchronized by turning an operating power supply of 24V ON/OFF.

In the present Example, an ON operation time difference between the first synchronization valve 310 and the second synchronization valve 320 was changed from −10 ms to +10 ms. Here, the time difference δt was expressed as a positive value when an ON time of the first synchronization valve 310 was earlier than that of the second synchronization valve 320. In this case, the first synchronization valve 310 may be connected to a vacuum source and the second synchronization valve 320 may be connected to the atmosphere. Here, after the vacuum is applied to the first synchronization valve 310, the atmospheric pressure may be applied to the second synchronization valve 320. In this case, the vacuum applied to the first synchronization valve may be released into the atmosphere, and the second synchronization valve may be opened into the atmosphere to apply the atmospheric pressure.

In addition, when the ON time of the first synchronization valve 310 lags behind that of the second synchronization valve 320, the time difference δt is expressed as a negative value. In this case, the first synchronization valve 310 may be connected to the atmosphere and the second synchronization valve 320 may be connected to the vacuum source. Here, after the atmospheric pressure is applied to the first synchronization valve 310, the vacuum may be applied to the second synchronization valve 320. In this case, the atmospheric pressure applied to the first synchronization valve 310 may be released and the vacuum may be applied to the first synchronization valve.

In addition, in order to measure the movement speed of the microfluid in the microfluidic channel 100, the other side of the microfluidic channel 100 was immersed in the sample solution 10. Here, as the sample solution 10, a black ink solution was used.

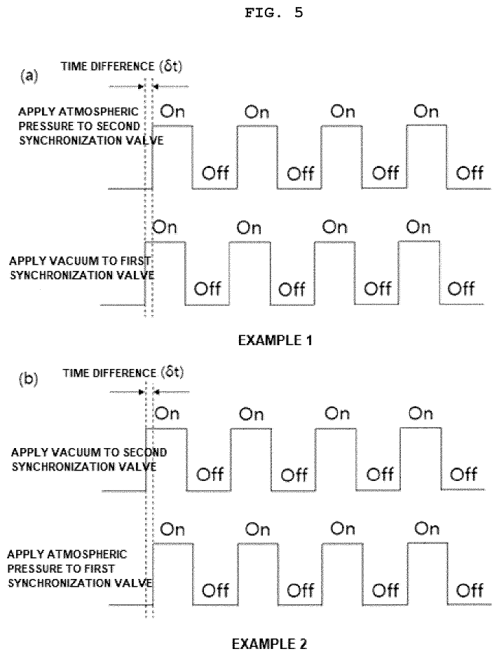

In the above Example, the results of measuring the movement speed of the sample solution 10 (black ink solution) in the microfluidic channel 100 are shown in <Table 1> below, divided into Examples 1 and 2, and the synchronous operation graph according to the time difference of the first synchronization valve and the second synchronization valve according to Examples 1 and 2 of the microfluidic control device using the synchronously operating dual valves according to the present disclosure was shown in FIG. 5.

### Example 1

Referring to FIG. 3, the first synchronization valve 310 is connected to the vacuum source so that vacuum may be applied, and the second synchronization valve is connected to the atmosphere so that the atmospheric pressure may be applied. Referring to (a) of FIG. 5, the first synchronization valve 310 connected to the vacuum source operates, and then the second synchronization valve 320 connected to the atmosphere operates with a fixed time difference δt, so the synchronous operation is possible. Referring to Example 1 of <Table 1> below, since the first synchronization valve 310 connected to the vacuum source operates, and then the second synchronization valve 320 connected to the atmosphere operates with a fixed time difference δt, so the suction flow velocity per second of the microfluidic channel may increase. To describe in detail, as the time difference changes from 10 to −10 ms, it may be seen that the suction flow velocity of the sample solution sucked into the microfluidic channel 100 decreases. Here, the first synchronization valve 310 may be connected to the vacuum source and the second synchronization valve 320 may be connected to the atmosphere. After the vacuum source is applied to the first synchronization valve 310, the atmospheric pressure may be applied to the second synchronization valve 320. Therefore, a very low vacuum is applied so that a trace of fluid may be sucked, thereby enabling very fine control.

### Example 2

Referring to FIG. 4, the first synchronization valve 310 is connected to the atmosphere to apply atmospheric pressure, and the second synchronization valve is connected to the vacuum source so that the vacuum may be applied. Referring to (b) of FIG. 5, the first synchronization valve 310 connected to the atmosphere operates, and then the second synchronization valve 320 connected to the vacuum source operates with a fixed time difference δt, so the synchronous operation is possible. Referring to Example 2 of <Table 1> below, since the first synchronization valve 310 connected to the atmosphere operates, and then the second synchronization valve 320 connected to the vacuum source operates with a fixed time difference δt, so the suction flow velocity per second of the microfluidic channel may decrease, thereby controlling a trace of microfluidic flow. To describe in detail, as the time difference changes from 0 to −10 ms, it may be seen that the suction flow velocity of the sample solution sucked into the microfluidic channel 100 increases. Here, the first synchronization valve 310 may be connected to the atmosphere and the second synchronization valve 320 may be connected to the vacuum source so that the vacuum may be applied. Therefore, after the vacuum source is applied to the first synchronization valve 310, a stronger vacuum may be applied to the second synchronization valve 320 than when atmospheric pressure is applied, so a relatively larger amount of fluid may be sucked, thereby enabling the flow control of the microfluid.

As shown in Examples 1 and 2 of <Table 1> below, when the time difference δt is changed from −10 ms to 10 ms, it was confirmed that the suction flow velocity of the fluid sucked into the microfluidic channel 100 may vary from 0.15 μL/s to 1.54 μL/s. Accordingly, as the first synchronization valve and the second synchronization valve are connected to the atmosphere or the vacuum source, the strength and action time of the effective vacuum transmitted to the microfluidic channel 100 connected to the pressure transfer flow path 200 may be arbitrarily adjusted. Accordingly, the microfluidic flow within the microfluidic channel 100 may be precisely controlled.

TABLE 1

| | Time difference (ms) between | Suction flow velocity |
|---|---|---|
| | first synchronization valve | (μL/s) |
| Division | and second synchronization valve | Average value |
| Example 1 | 10 | 1.54 |
| | 5 | 0.93 |
| | 3 | 0.62 |
| | 2 | 0.48 |
| | 1 | 0.34 |
| | 0 | 0.30 |
| Example 2 | −1 | 0.28 |
| | −2 | 0.26 |
| | −3 | 0.24 |
| | −5 | 0.21 |
| | −10 | 0.15 |

It was confirmed that the suction flow velocity of few μL of microfluid in the microfluidic channel 100 may be precisely controlled by applying the vacuum and atmospheric pressure using the microfluidic control device 1000 using synchronously operating dual valves of the present disclosure.

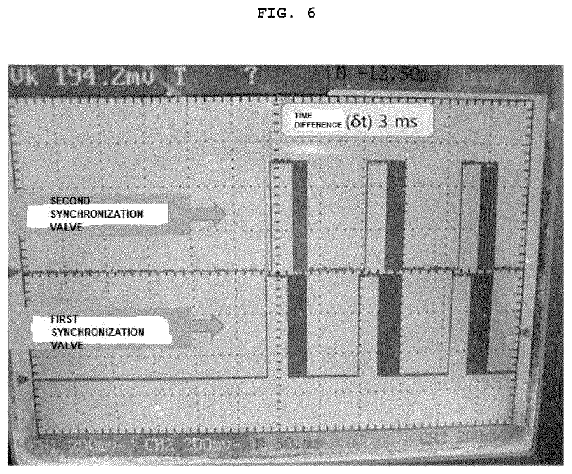

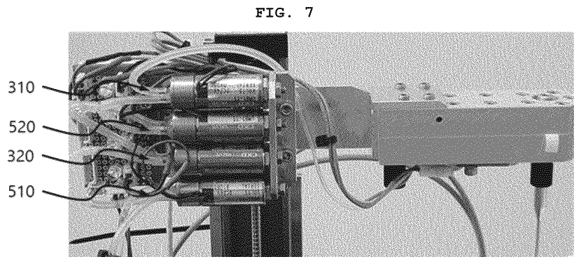

FIG. 6 illustrates an experimental result of operating the microfluidic control device using synchronously operating dual valves of the present disclosure, and FIG. 7 illustrates an actual photograph of the microfluidic control device using synchronously operating dual valves of the present disclosure. As illustrated shown in FIGS. 6 and 7, the microfluidic flow velocity precise-control device using synchronously operating dual valves and the method according to the present disclosure enable synchronous operation in which the first synchronization valve 310 and the second synchronization valve 320 operate with a fixed time difference δt, so the microfluidic flow in the microfluidic channel 100 may be precisely controlled.

In addition, the strength and operating time of the effective vacuum transmitted to the microfluidic channel 100 connected to the pressure transfer flow path 200 may be arbitrarily adjusted, so the microfluidic flow in the microfluidic channel 100 may be precisely controlled, and the flow velocity of the microfluid may be variously adjusted depending on the purpose.

Therefore, by precisely controlling the transport of the trace sample within the microflow path, the flow velocity of the microfluid may be easily and simply controlled in fields requiring various microfluids such as microanalysis and microreaction, and since no separate special purpose device or part is required for the control of the flow velocity of microfluid, there is an effect of easily and economically implementing the precise control of the flow velocity of the microfluid.

The present disclosure is not limited to the above-described Examples, but may be variously applied, and may be variously modified without departing from the gist of the present disclosure claimed in the claims.

### INDUSTRIAL APPLICABILITY

The microfluidic flow velocity precise-control device using synchronously operating dual valves and the microfluidic flow velocity precise-control method using the same according to the present disclosure can easily and simply control a flow velocity of a microfluid in fields requiring various microfluids, and can easily and economically implement precise control of the flow velocity of the microfluid.

1. A microfluidic control device using synchronously operating dual valves, comprising:
a microfluidic channel in a form of a capillary;
a pressure transfer flow path that is connected to one side of the microfluidic channel;
a first control unit that is connected to one side of the pressure transfer flow path;
a second control unit that is connected to the other side of the pressure transfer flow path; and
a synchronization valve controller that is connected in series with the first control unit and the second control unit.

2. The microfluidic control device of claim 1, wherein the first control unit includes:
a first synchronization valve that is connected to one side of the pressure transfer flow path;
a first pressure source that is connected to the first synchronization valve through a first pipe to apply pressure; and
a synchronization valve controller that is connected to the first synchronization valve through a first conductor to control an applied time.

3. The microfluidic control device of claim 1, wherein the second control unit includes:
a second synchronization valve that is connected to the other side of the pressure transfer flow path;
a second pressure source that is connected to the second synchronization valve through a second pipe to apply pressure; and
a synchronization valve controller that is connected to the second synchronization valve through a second conductor to control an applied time.

4. The microfluidic control device of claim 1, wherein the synchronization valve controller operates the first synchronization valve and the second synchronization valve at a preset time interval.

5. The microfluidic control device of claim 2, wherein the synchronization valve controller operates the first synchronization valve and the second synchronization valve at a fixed time difference (δt) in a range of 0 to ±100 ms.

6. The microfluidic control device of claim 1, wherein the microfluidic channel includes a fluid in a range of 0.1 to 500 μL.

7. The microfluidic control device of claim 1, wherein the first synchronization valve applies negative pressure or positive pressure to the pressure transfer flow path by the operation of the first pressure source.

8. The microfluidic control device of claim 1, wherein the second synchronization valve adjusts the pressure applied to the pressure transfer flow path by the operation of the second pressure source.

9. A microfluidic control method using the microfluidic control device of claim 1, comprising:
a first synchronization step of controlling a first synchronization valve, which is connected to one side of a pressure transfer flow path connected to one side of a microfluidic channel, by a synchronization valve controller connected to a first conductor; and
a second synchronization step of controlling a second synchronization valve, which is connected to the other side of the pressure transfer flow path connected to one side of the microfluidic channel, by the synchronization valve controller connected to a second conductor.

10. The microfluidic control method of claim 9, wherein the first synchronization step includes:
a first pressure application step of applying pressure to the first synchronization valve by a first pressure source connected to the first synchronization valve through a first pipe; and
after the first pressure application step, a first control step of controlling a time applied to the first synchronization valve by the synchronization valve controller connected to the first synchronization valve through a first conductor.

11. The microfluidic control method of claim 9, wherein the second synchronization step includes:
a second pressure application step of applying pressure to the second synchronization valve by a second pressure source connected to the second synchronization valve through a second pipe; and
after the second pressure application step, a second control step of controlling a time applied to the second synchronization valve by the synchronization valve controller connected to the second synchronization valve through a second conductor.

12. The microfluidic control method of claim 9, wherein, in the first synchronization step and the second synchronization step, the first synchronization valve and the second synchronization valve operate at a fixed time difference (δt) by the synchronization valve controller.

13. The microfluidic control method of claim 12, wherein, in the first synchronization step and the second synchronization step, the first synchronization valve and the second synchronization valve operate at the fixed time difference (δt) in a range of 0 to ±100 ms by the synchronization valve controller.
